(19) United States
(12) Patent Application Publication
(10) Pub. No.: US 2005/0050246 A1
(43) Pub. Date: Mar. 3, 2005

(54) Method of admission control

(75) Inventors: Jani Lakkakorpi, Helsinki (FI); Ove Strandberg, Lappbole (FI); Jukka V. Salonen, Tampere (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: NOKIA CORPORATION

(21) Appl. No.: 10/745,669

(22) Filed: Dec. 29, 2003

(30) Foreign Application Priority Data
Sep. 1, 2003 (GB) 0320469.0

(51) Int. Cl. G06F 3/00

(52) U.S. Cl. 710/36

(57) ABSTRACT

A method of for controlling the admission of a connection comprising; a) providing a plurality of classes; b) reserving for at least one class a portion of a bandwidth; c) determining usage related information by at least one of the classes to which a respective portion of said bandwidth has been reserved; and d) controlling admission of at least one class, different to the at least one class for which usage has been determined, said admission taking into account said determined usage related information.

### FIELD OF THE INVENTION

The present invention relates to a method of admission control and in particular but not exclusively to admission control and scheduling weight management in a packet switched network with quality of serve provisioned by Differentiated Services mechanism.

### BACKGROUND OF THE INVENTION

The last mile in many access networks consists of narrow-bandwidth links, e.g., leased lines. Differentiated Services (DiffServ) can help to utilize these links in the most effective manner. DiffSev provides differentiated classes of service for Internet traffic to support various types of applications and specific business requirements. Other solutions tend not to be as scalable. DiffServ is described in for example S. Blake, D. Black, M. Carlson, E. Davies, Z. Wang and W. Weiss, “An Architecture for Differentiated Services”, Request For Comments 2475 (an IETF Internet Engineering Task Force document), December 1998 which is hereby incorporated by reference. DiffServ is managed through Service Level Agreements (SLAs). If such networks do not have dynamic admission control as discussed in L. Breslau, S. Jamin, and S. Shenker, “Comments on the Performance of Measurement-based Admission Control Algorithms”, Proceedings of IEEE Infocom 2000, pp. 1233-1242, Tel Aviv, Israel, March 2000 which is hereby incorporated by reference, the narrow-bandwidth access networks could become heavily congested (no admission control at all) or underutilized (too strict parameter-based admission control). Admission control in DiffServ based networks can be done utilizing Bandwidth Brokers (see for example K. Nichols, V. Jacobson (Cisco Systems) and L. Zhang (UCLA), “A Two-bit Differentiated Services Architecture for the Internet”, Request For Comments RFC 2638 (an IETF document), July 1999 which is hereby incorporated by reference or Schelen, “Quality of Service Agents in the Internet”, Ph.D. thesis, Division of Computer Communication, Department of Computer Science and Electrical Engineering, Lulea University of Technology, August 1998) which is hereby incorporated by reference. In the IETF RFC 2638, Nichols et al. have introduced a concept of a Bandwidth Broker agent that has the information of all resources in a specific domain. The Bandwidth Broker could be consulted in admission control decisions. In addition to RFC 2638, QBone Bandwidth Broker Advisory Council home page (QBone Bandwidth Broker Advisory Council home page, June 2003) which is hereby incorporated by reference provides information on Bandwidth Brokers.

O. Schelén in his thesis has presented an admission control scheme for Bandwidth Brokers, where clients can make reservations between any two points through Quality of Service (i.e. Bandwidth Broker) agents. Each routing domain has its own Quality of Service agent that maintains information about reserved resources on each link in its routing domain. The Bandwidth Broker knows the domain topology by listening to OSPF. open shortest path first routing protocol. (see J. T. Moy, OSPF: Anatomy of an Internet Routing Protocol, 3rd printing, Addison-Wesley, Reading, MA, 1998, ISBN 0-201-63472-4 which is hereby incorporated by reference) messages, and link bandwidths are obtained through Simple Network Management Protocol (SNMP). Reservations from different sources to the same destination are aggregated as their paths merge towards the destination. Bandwidth Brokers are responsible for setting up police points at the network edges.

Since Schelén designed his scheme for supporting advance reservations, parameter-based admission control (PBAC) was chosen over measurement-based admission control. Moreover, PBAC provides hard guarantees, which is very desirable for virtual leased lines. In today's DiffServ framework, virtual leased lines could mean, for example, Expedited Forwarding (EF) aggregates as described in B. Davie, A. Charny, J. C. R. Bennett, K. Benson, J. Y. Le Boudec, W. Courtney, S. Davari, V. Firoiu and D. Stiliadis, “An Expedited Forwarding PHB”, Request For Comments 3246 (Obsoletes RFC 2598)—and IETF document, March 2002 which is hereby incorporated by reference.

In Nokia's IP RAN (Internet protocol Radio Access network), ITRM (IP Transport Resource Manager) supports the CAC (connection admission control) by providing information (bandwidth limits) about the transport network loading levels. The current ITRM SFS System feature specification CAC algorithm guarantees bandwidth for real time (RT) radio access bearers (RABs). These RT RABs belong to either conversational or streaming 3G (the so-called third generation) traffic class. In IP RAN, conversational Iu and all Iur' traffic is mapped to EF, while streaming Iu traffic is mapped to AF4.

In ITRM SFS, it is assumed that AF4 scheduling weights are configured in “strict priority -fashion”. This means that the ratio of AF4 scheduling weight to other AF weights is close to 0.99:0.01. Together with the current ITRM SFS CAC algorithm, this will assure guaranteed bandwidth for conversational and streaming traffic classes. However, some non-real time (NRT) connections belonging to 3G interactive traffic class (mapped to AF3, AF2 and AF1) may be adversely affected by the delay and jitter which is caused by the “strict priority-like” AF4 weight.

A cAc algorithm (for Bandwidth Broker) that does not require “strict priority-like” AF4 weights has been proposed in J. Lakkakorpi, “Simple Measurement-Based Admission Control for DiffServ Access Networks”, Proceedings of SPIE ITCom 2002, Boston, USA, July-August 2002.

Expedited Forwarding EF is a per hop behavior PHB. The PHB is the basic building block in the DiffServ architecture. EF is intended to provide building block for low delay, low jitter and low loss services by ensuring that the EF aggregate is served at a certain configured rate. EF is such that the rate at which EF traffic is served at a given output interface should be at least the configured rate R over a suitably defined interval, independent of the offered load of non-EF traffic to that interface.

Assured forwarding AF PHB provides delivery of IP packets in four independently forwarded AF classes. Within each AF class, an IP packet can be assigned one of three different levels of drop precedence. Assured Forwarding (AF) PHB group is a means for a provider DiffServ domain to offer different levels of forwarding assurances for IP packets received from a customer DiffServ domain. Four AF classes are defined, where each AF class is in each DiffServ node allocated a certain amount of forwarding resources (buffer space and bandwidth). IP packets that wish to use the services provided by the AF PHB group are assigned by the customer or the provider DiffServ domain into one or more of these AF classes according to the services that the customer has subscribed to.

Within each AF class IP packets are marked (again by the customer or the provider of the DiffServ domain) with one of three possible drop precedence values. In case of congestion, the drop precedence of a packet determines the relative importance of the packet within the AF class.

A congested DiffServ node tries to protect packets with a lower drop precedence value from being lost by preferably discarding packets with a higher drop precedence value.

In a DiffServ node, the level of forwarding assurance of an IP packet thus depends on (1) how much forwarding resources has been allocated to the AF class that the packet belongs to, (2) what is the current load of the AF class, and, in case of congestion within the class, (3) what is the drop precedence of the packet.

For example, if traffic conditioning actions at the ingress of the provider DiffServ domain make sure that an AF class in the DiffServ nodes is only moderately loaded by packets with the lowest drop precedence value and is not overloaded by packets with the two lowest drop precedence values, then the AF class can offer a high level of forwarding assurance for packets that are within the subscribed profile (i.e., marked with the lowest drop precedence value) and offer up to two lower levels of forwarding assurance for the excess traffic.

There are problems with the known schemes. Firstly there is the problem relating to the use of normal (vs. strict priority like) scheduling weights and secondly bursty connection arrivals.

In particular the use of the strict priority scheduling favors the streaming class (AF4). The side effect is that interactive class (like in AF3) will see a longer transport delay. This is not good as many times the interactive class (like games) would benefit from a low delay while the streaming does not have so stringent requirement on delay. The reason for the strict priority scheduling is that with priority the streaming class can get enough bandwidth BW to handle the high throughput needed. However the allocation of BW through scheduling also goes hand in hand with lower delay for the higher priority class.

It has been noted that services targeted for the AF3 can not cope with more delay than streaming in the AF4 class. Thus the delay should be smaller for AF3 if the delay budget is not enough (perhaps because of transport network design)

### SUMMARY OF THE INVENTION

It is an aim of embodiments of the present invention to address one or more of the above mentioned problems.

Aspects of the present invention can be seen from the appended claims.

### BRIEF DESCRIPTION OF DRAWINGS

For a better understanding of the present invention and as to how the same may be carried into effect, reference will now be made by way of example to the accompanying drawings in which:

FIG. 1 shows Bandwidth brokers, other CAC agents and their routing domains;

FIG. 2 shows Load/reservation limit hierarchy;

FIG. 3 shows an example of a flexible CAC algorithm with admission decisions for EF1, AF1 and AF2 connections;

FIG. 4 shows an example of access network topology;

FIG. 5 shows simulation results for the joint admission ratios for EF, AF1 and AF2;

FIG. 6 shows simulation results for average EF, AF1 and AF2 loads;

FIG. 7 shows simulation results for AF1 bottleneck link delays;

FIG. 8 shows simulation results for AF2 bottleneck link delays

FIG. 9 shows simulation results for AF1 packet loss;

FIG. 10 shows simulation results for AF2 TCP throughput;

FIG. 11 shows simulation results for AF3 TCP throughput;

FIG. 12 shows Adaptive AF1 and AF2 weights;

FIG. 13 shows Adaptive EF and RT reservation limits; and

FIG. 14 shows a flow chart of a method embodying the present invention.

### DETAILED DESCRIPTION OF PREFERRED EMBODIMENTS OF THE PRESENT INVENTION

Embodiments of the present invention provide a scheme that can be used in IP RAN for providing guaranteed bandwidth for streaming traffic while simultaneously providing better latency for interactive traffic. Embodiments of the present invention enable the nuse measurement-based admission control (MBAC) in addition to the more traditional parameter-based admission control (PBAC). Two connection admission control schemes for the modified Bandwidth Broker framework will now be described: Simple CAC and Flexible CAC. Both schemes have proved to be very efficient in the terms of bottleneck link utilization when used in the “MBAC mode”. Two problems are addressed—the use of normal (vs. strict priority like) scheduling weights and bursty connection arrivals. The former one can be dealt with the use of adaptive scheduling weights while the latter one can be fought with adaptive reservation limits.

Due to the fact that average bit rates can be substantially lower than the corresponding requested peak rates, the use of parameter-based admission control can leave the network underutilized. Link load measurements are needed for more efficient network utilization. EF and Best Effort (BE) loads have already been suggested for the QBone architecture. In theory, it is possible that all admitted traffic sources start sending data at their peak rates at the same time. However, the probability for this is extremely small—especially if the number of traffic sources is very high. Moreover, it is possible to protect against such an event by carefully combining MBAC and PBAC.

Embodiments of the present invention provide a flexible admission control mechanism for DiffServ access networks by extending and modifying the existing Bandwidth Broker framework. The information needed for measurement-based admission control decisions—link loads—is retrieved from router statistics and it is periodically sent to the Bandwidth Broker agent of a routing domain. As a second enhancement, connection admission control for multiple traffic classes, e.g., EF, AF1 and AF2 is provided. The motivation for doing CAC for selected Assured Forwarding (AF) traffic is that there are real time applications with relaxed QoS requirements. These traffic sources (e.g., video or audio streaming) do not need the “virtual wire” (EF) treatment. Some statistical guarantees, however, should be provided.

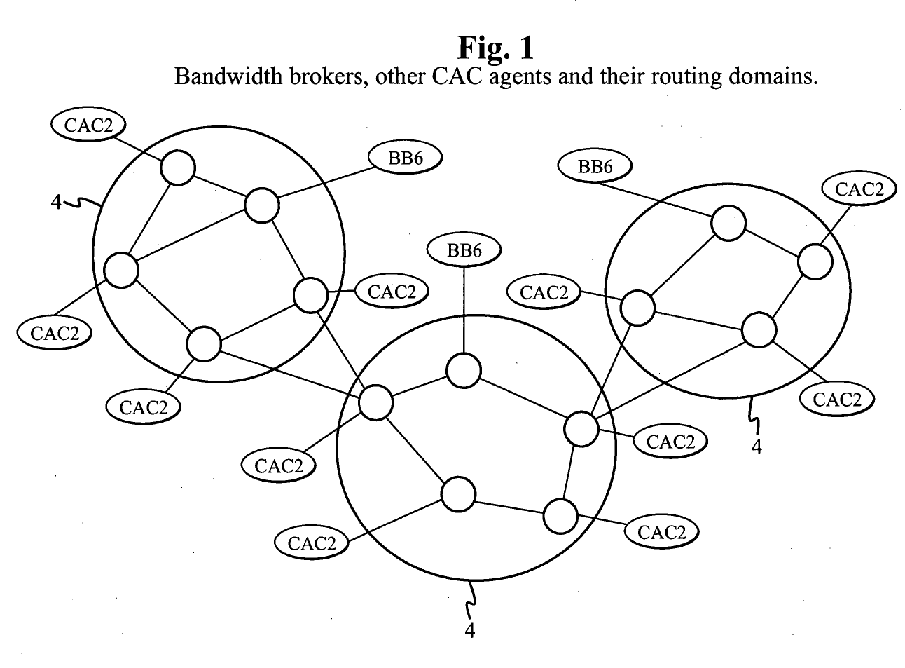

Reference is made to FIG. 1 which shows schematically an embodiment of the invention. In the modified Bandwidth Broker framework embodying the invention, a Connection Admission Control (CAC) agent 2 is provided in all routing domain nodes. In FIG. 1, three routing domains 4 are shown with routing nodes. The routing nodes are either labeled CAC or BB. Nodes which are labeled CAC 2 provide the Connection admission control function. One of these CAC agents in each routing domain will act as the Bandwidth Broker BB 6 by storing the information on reservations and measured link loads within the routing domain. The Bandwidth Broker BB6 knows the routing topology by listening to OSPF messages. Link bandwidths within the routing domain are obtained through SNMP.

In addition to reserved link capacities for different traffic classes, the admission decision is based on measured link loads on the path between the endpoints. If there is not enough both unoccupied and unreserved bandwidth on the path, the connection is blocked. Maximum reservable bandwidth on a link can exceed link capacity. Thus, when the maximum reservable bandwidth is high enough, it is the unoccupied bandwidth only that matters. The relationship between the maximum reservable bandwidth and link bandwidth is configurable for each traffic class.

All CAC agents monitor and update their link loads by using exponential averaging on the statistics obtained from their local router. See equations (1) and (2) The number of dequeued bits during a sampling period (s) is obtained e.g., using SNMP. A suitable value for s could be, for example, 500 ms. During a single measurement period (p), the link loads are sampled p/s times, and at the end of each measurement period the maximum value is selected to represent the current load. A suitable range for measurement period (p) values could be from one to ten seconds. Exponential averaging weight (w), measurement period and sampling period should be carefully selected. The optimal values for w and p depend on traffic patterns and how fast they are to adapt to changes in link loads. Small value for s makes the scheme more sensitive to bursts while larger values might give a better estimation of the average load. CAC agents send their link loads every p seconds to the Bandwidth Broker of the domain. These packets should be given the best possible treatment in terms of delay and packet loss. Whenever a load report arrives to Bandwidth Broker agent, the link database is updated by re-calculating the applicable unoccupied link bandwidths for each traffic class as in equation (3). Bw is bandwidth. Unreserved bandwidths are updated whenever a reservation is setup or torn down as in equation (4). Available bandwidths are calculated only when there is a resource request for a specific path using equation (5).
load_{class}:=(1−w)*load_{class}+w*currentLoad_{class} (1)
currentLoad_{class}:=max(dequeuedBits_{class}(1), . . . , dequeuedBits_{class}(p/s))/(s*bw) (2)
unoccupiedBw_{class}=bw*(loadLimit_{class}−load_{class}) (3)
unreservedBw_{class}=bw*(reservationLimit_{class}−reserved_{class}) (4)
availableBw_{class, path}=min(unoccupiedBw_{class,link}, unreservedBw_{class,link}|∀linkεpath) (5)
With bw the link bandwidth (bps—bits per second) is denoted, load_{class} denotes the measured link load (0 . . . 1) for a given class while reserved_{class} denotes the reserved link capacity (0 . . . 1) for a given class. For AF classes, the calculation of available bandwidth can be more complex. This is due to weighted scheduling between AF queues. Either the weights for all AF queues in strict priority fashion can be configured and equations (3), (4) and (5) applied or the AF weights (weight_{AFi}) can be taken into account when calculating the unoccupied bandwidth values for each link using equation (6). The sum of all AF weights is one.
unoccupiedBw_{AFi}=bw*min((loadLimit_{AFi}−load_{AFi}), (1−load_{EF}−load_{AFi}/weight_{AFi})) (6)

In a further embodiment of the invention, flexible connection admission control is provided. In Simple CAC, which is a subset of Flexible CAC, admission control is done for real time traffic (mapped to EF and AF1) only. Thus, it may be hard or even impossible to use business or any other objectives in CAC decisions—it is necessary to concentrate on real time application requirements. In Flexible CAC, real time connections cannot claim all the bandwidth since link bandwidth between RT and NRT (non real time) traffic is shared dynamically. Instead of a constant value, the load limit for RT traffic will be the minimum of total load limit less NRT traffic load and maximum RT load limit using equation (7). Similarly, the load limit for NRT traffic will be the minimum of total load limit less RT traffic load and maximum NRT load limit as defined by equation (8). The whole link bandwidth may not be utilized for RT traffic without having large delays. The total load limit is there in order to protect Best Effort traffic (or any non-admission controlled traffic)—if one wants to protect it. Moreover, the reserved link capacities may be taken into account in the admission decisions—reservation limits for RT and NRT traffic are calculated just like the load limits using equations (9-10). Parameter- or measurement-based admission control can be prioritized by tuning the maximum capacity that can be reserved for a given traffic class on a link (reservationLimit_{class}). If the reservation limit is small enough, it will be the parameter-based admission control that will rule.

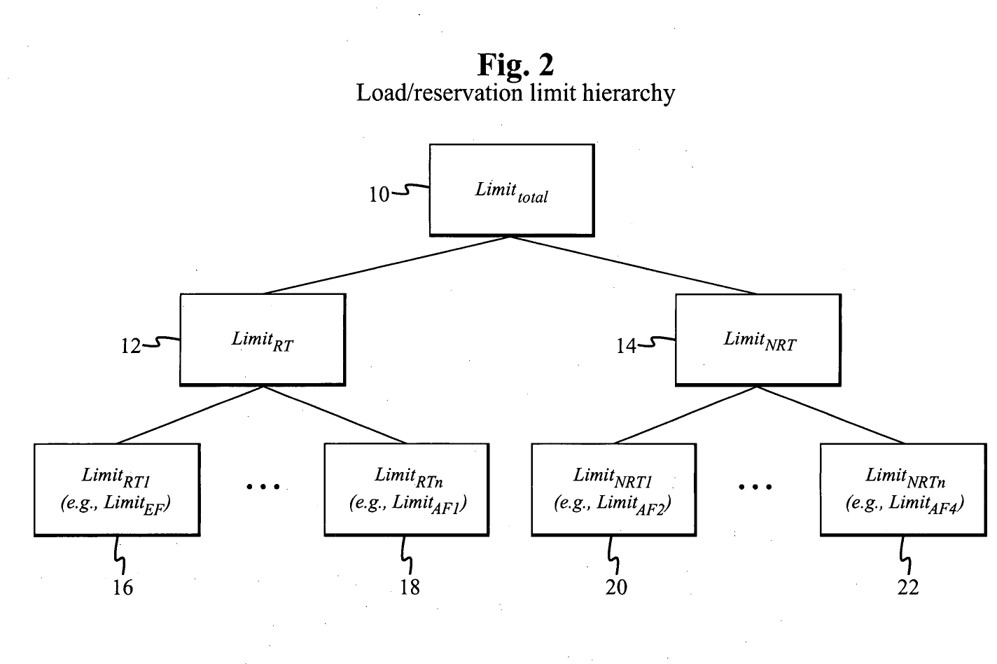

FIG. 2 illustrates the load/reservation limit hierarchy. Three limits can affect each admission decision: total limit—this is referenced 10 and represents the total bandwidth. The next later is divided into two RT/NRT limits which are referenced 12 and 14 respectively. The RT limit 12 in the next level is divided in to a plurality of limits, two of which 16 and 18 are shown. The first limit 16 may be the EF limit whilst the second limit 18 may be the AF1 limit. The NRT limit 14 may in the next level be divided into a plurality of limits, two of which are shown 20 and 22. Limit 22 represents the AF3 limit and limit 22 represents the AF4 limit. It should be appreciated that this is only one example of the limit hierarchy and any other suitable hierarchy can be used where the number of layers, the number of limits in the layers and the criteria used to provide the layers can be changed.

It should be appreciated that each level in the hierarchy does not have to have an effect i.e. for example, the NRT limit can be set to equal the total limit. Note that a limit cannot exceed its parent class limit.
loadLimit_{RT}=min((loadLimitₜₒₜₐₗ−load_{NRT}), loadLimit_{RT}_{_{—}}_{MAX}) (7)
loadLimit_{NRT}=min((loadLimitₜₒₜₐₗ−load_{RT}), loadLimit_{NRT}_{_{—}}_{MAX}) (8)
reservationLimit_{RT}=min((reservationLimitₜₒₜₐₗ−reserved_{NRT}), reservationLimit_{RT}_{_{—}}_{MAX}) (9)
Error! Objects cannot be created from editing field codes. (10)

One way to apply Flexible CAC is to configure all AF scheduling weights in strict priority fashion so that AF1 has the biggest weight—this results in delay differentiation between different AF classes and it eliminates the “stolen bandwidth” phenomenon discussed in J. Lakkakorpi, “Simple Measurement-Based Admission Control for DiffServ Access Networks”, Proceedings of SPIE ITCom 2002, Internet Performance and Control of Network Systems III, pp. 108-119, Boston, Mass., USA, July 2002.

However, it is also possible to apply equation (6) for calculating the unoccupied bandwidths for AF classes. The latter method will most probably result into lower admission ratios and resource utilization, but it may be useful when the goal of using AF is not delay differentiation but something else—like bandwidth sharing.

In addition to dynamic RT and NRT limits, there is a coefficient that is a function of the price the user is paying for a given service. The requested bandwidth (peak rate) is multiplied by this coefficient, and the result is compared to available bandwidth. If, for example, f(price)=1.0, connections with the smallest peak rates are favoured.

In Flexible CAC, RT could denote, for example, the aggregate EF and AF1 traffic classes. However, the scope of RT can be extended to cover more traffic classes. Similarly, NRT could include just AF2 traffic, but its scope can be extended to cover more traffic classes (see FIG. 2 Error! Reference source not found.). Adjustable parameters are the following: loadLimitₜₒₜₐₗ, loadLimit_{RT}_{_{—}}_{MAX}, loadLimit_{NRT}_{_{—}}_{MAX}, reservationLimitₜₒₜₐₗ, reservationLimit_{RT}_{_{—}}_{MAX}, reservationLimit_{NRT}_{_{—}}_{MAX} and the load and reservation limits of individual traffic classes (e.g., EF, AF1, AF2).

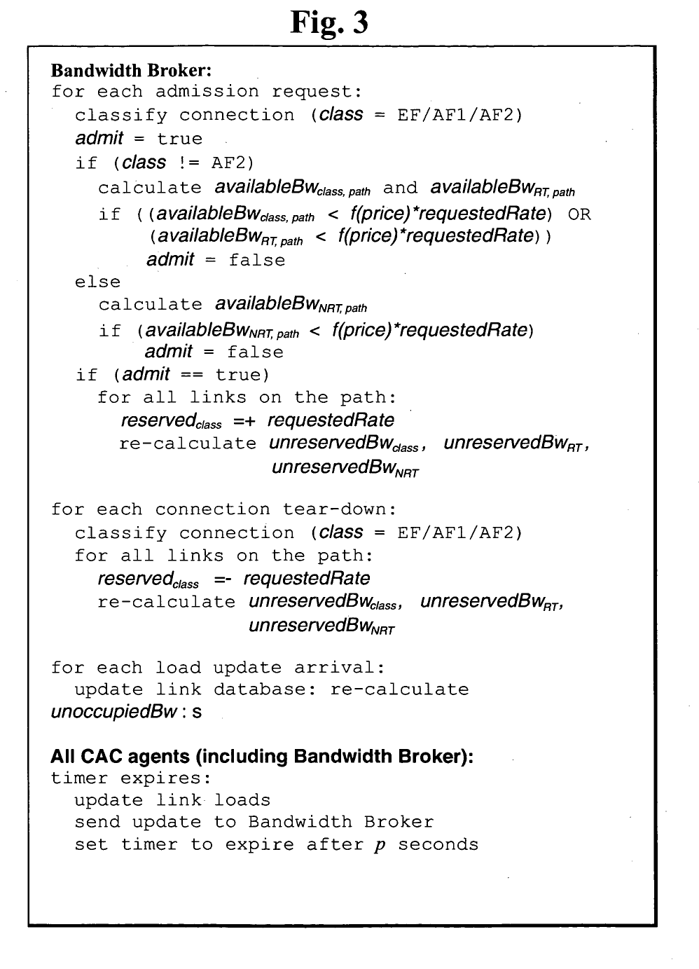

FIG. 3 illustrates how admission decisions are made in an example Flexible CAC instance with three traffic classes. New connections request resources (peak rate from source to destination) from the Bandwidth Broker of their own routing domain. Other Bandwidth Brokers may have to be consulted as well if the destination is not in the same domain. If there are enough resources, the requested bandwidth for the admitted connection is added to reserved values for all links along the path. Otherwise, the connection is rejected. Policing is needed for all admitted flows to keep their peak bit rates below the agreed ones.

In more detail, in FIG. 3, the Bandwidth broker carries out the following for each admission request:

Classify the connection—that is it EF, AF1 or AF2 for each admission request:

```
    admit = true
          if ( the class is AF2) then
              calculate availableBw_{class, path} and availableBw_{RT, path}
                - if ((availableBw_{class, path} < f(price)*requestedRate) OR
                (availableBw_{RT, path} < f(price)*requestedRate))
        admit = false − that is connection not admitted
  otherwise
    calculate availableBw_{NRT, path}
          if (availableBw_{NRT, path} < f(price)*requestedRate)
          admit = false that is connection not admitted
  if (admit == true)
    for all links on the path:
      reserved_{class} =+ requestedRate
      re-calculate  unreservedBw_{class},  unreservedBw_{RT},
unreservedBw_{NRT}
for each connection tear-down:
  classify connection (class = EF/AF1/AF2)
  for all links on the path:
    reserved_{class} =− requestedRate
    re-calculate unreservedBw_{class}, unreservedBw_{RT}, unreservedBw_{NRT}
for each load update arrival:
  update link database: re-calculate unoccupiedBw:s
```

For all CAC Agents (Including Bandwidth Broker):

When the timer expires:
1. update link loads
2. send update to Bandwidth Broker
3. set timer to expire after p seconds

As explained previously, both Simple CAC and Flexible CAC offer two operating modes for calculating the available bandwidth for AF classes: there are either strict priority like AF weights and they are omitted in the calculation or the normal AF weights are taken into account when calculating the available bandwidths. If the Best Effort traffic is to be protected (also in shorter time scale—the total limits take care of the protection in longer time scale), the latter mode is preferable.

With Simple CAC, there is no need to tune the scheduling weights due to the fact that there are only two AF classes—and the other one, AF2, is the Best Effort. Thus, fixed weight allocations should be enough. With Flexible CAC, however, it may be desired to tune the AF1 and AF2 weights. An example of flexible CAC with three classes, where EF and AF1 classes belong to the RT superclass is now described. If the Best Effort class, AF3, is given a fair share of forwarding resources, say 10%, it is impossible to have strict priority like weights (e.g., 90:9:1) for the three AF classes. Moreover, static AF weights could result into low bottleneck link utilization.

The AF weights are tuned individually for each link. The tuning process receives periodic input about the unoccupied AF bandwidths for every link within the Bandwidth Broker area. If certain thresholds are reached, new AF scheduling weights for the involved links and the CAC algorithm are calculated. In one embodiment of the invention the weight ratio of the non-real-time AF-classes is maintained. It should be appreciated that some other inputs such a queue filling level, packet loss and throughput could be used as well. Once the new AF weights have been calculated, they are immediately taken into use.

The Bandwidth Broker monitors continuously (as new router notifications arrive) the unoccupiedBw_{AFi} values. The smallest values from each link during a measurement period, T_{W} (e.g., 10 seconds), are stored into link database. After each periodical check (every T_{W} seconds) these values are reset. If certain thresholds are reached, new AF weights are calculated for the involved links. If the smallest unoccupiedBw_{AFi}/bw value is smaller than lowThreshold (e.g., 0.05) or larger than highThreshold (e.g., 0.15), update weight_{AFi}.
weight_{AFi}=load_{AFi}/(1−load_{EF}−unoccupied) (11)

EF and AF loads are from the moment with smallest unoccupiedBwAFi. unoccupied denotes the amount of unoccupied capacity that we would like to be always available, e.g., 0.1. In general, lowThreshold<unoccupied<highThreshold. A negative unoccupiedBw_{AFi} value will immediately (vs. periodic checks) trigger AF weight tuning. The final AF weights depend on the number of AF classes (N), excluding the “Best Effort” class (12).

$${weight}_{AFi} := {weight}_{AFi} / ( {\sum }_{j = 1}^{N} {weight}_{AFj} ) * ( 1 - {weight}_{BE} ) \qquad ( 12 )$$

However, minimum (0.1*(1.0−weight_{BE})) and maximum (0.9*(1.0−weight_{BE}) values for an AF weight are enforced. It should be appreciated that other minimum and maximum values for AF weights can be alternatively or additionally used. Best Effort weight is configurable—it could be e.g., 0.1.

A further embodiment of the present invention will now be described in which it is possible to link together connection admission control (CAC) in IP Transport Resource Manager (ITRM) and tuning of a rate limiter that limits the throughput of AF3 queue. The rate tuning is based on unused AF4 bandwidth values calculated by ITRM.

The CAC algorithm for ITRM embodying the invention, does not need “strict priority-like” weights for AF4 queues in order to provide guaranteed bandwidth. The “strict priority-like” weights are provided for the AF3 queues in order to provide a smaller delay for interactive traffic. However, in order to provide guaranteed bandwidth for AF4, the AF3 queues are provided with a rate limiter such as Cisco's CAR (see Cisco Systems, Inc., “Committed Access Rate”, April 2003 which is hereby incorporated by reference) or something similar.

In some embodiments a static AF3 rate might be used, but it may be an ineffective use of available resources due to dynamical traffic mix and demand. Thus, embodiments of the present invention provide a mechanism for tuning the AF3 rate.

The rate limiter tuning process receives periodic input about unused AF4 bandwidth for every link within the ITRM area. If certain thresholds are reached, new rates for the relevant AF3 queues are calculated. The following example is one way to do this.

One example of an embodiment of the present invention will be described. Embodiments of the present invention can be used both in Nokia's ITRM admission control framework and in the modified Bandwidth Broker framework described in J. Lakkakorpi, “Simple Measurement-Based Admission Control for DiffServ Access Networks”, Proceedings of SPIE ITCom 2002, Boston, USA, July-August 2002 which is hereby incorporated by reference. The ITRM case is presented here as an example.

The following assumptions are made. An enhanced CAC algorithm that does not assume “strict priority—like” weight for AF4. It is assumed that there is CAC for all traffic mapped to EF—including NRT Iur' traffic. However, the key enhancement here is that AF3 throughput has an effect on unused AF4 bandwidth.
UnusedBw_{EF}=bw×(TLim_{EF}−throughput_{EF})
UnusedBw_{AF4}=bw×min((TLim_{AF4}— throughput_{AF4}), (1−throughput_{EF}−throughput_{AF4}−throughput_{AF3}))
UnusedBw_{RT}=bw×(TLim_{RT}−throughput_{EF}−throughput_{AF4})

$${UnusedBw}_{CLASS} := {UnusedBw}_{CLASS} * \frac{1}{{x}^{ITRM\_prm \_share}}$$
BLim_{CLASS, path}=min(UnusedBw_{CLASSlink}|∀linkεpath)+allocated_{CLASS, path}

For EF connections, check at BTS that:
requested rate+allocated_{EF, path}≦BLim_{EF, path}
requested rate+allocated_{RT, path}≦BLim_{RT, path}

For AF4 connections, check at BTS that:
requested rate+allocated_{AF4, path}≦BLim_{AF4}, path
requested rate+allocated_{RT, path}≦BLim_{RT, path}
   where UnusedBw is the unused bandwidth with the subscript indicating if it is for EF, AFn or the class
      bw is the bandwidth
      TLim is time limit with the subscript indicating if it refers to AFn or EF,
      Blim is the bandwidth limit with the subscript indicating if it is for AFn, EF or RT or the class for a path

The rest of the terms are self explanatory.

It should be appreciated that allocated_{RT}−allocated_{EF}+allocated_{AF4}

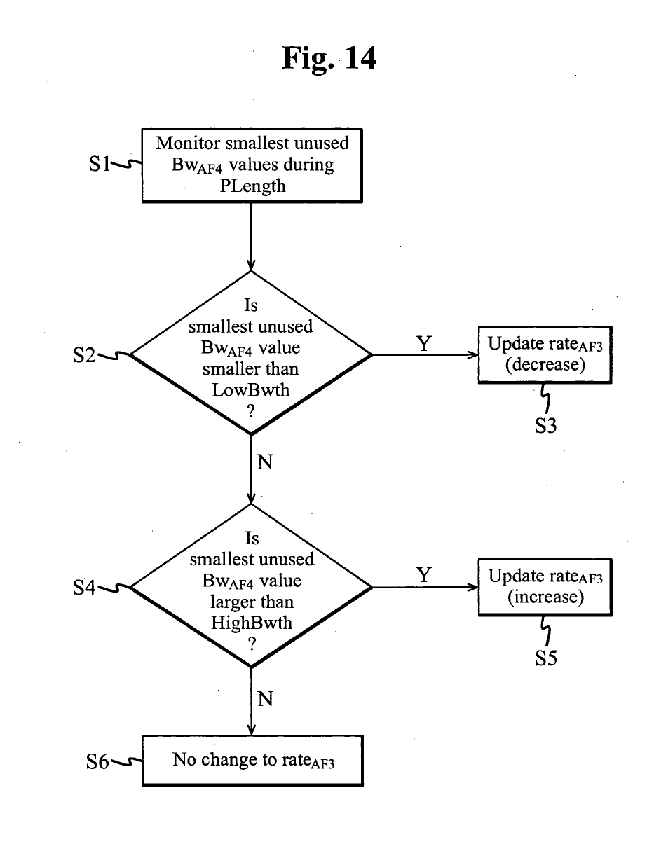

Reference will now be made to FIG. 14 which shows a flow chart of an embodiment of the invention. In step S1, ITRM monitors the smallest UnusedBw_{AF4} values during a measurement period (PLength). After each periodic check, these values are reset.

Periodic checks are made every PLength (e.g., 10) minutes. If certain thresholds are reached, calculate new rates for the AF3 queues.

In step S2, it is determined if smallest UnusedBw_{AF4} value is smaller than LowBwTh lower bandwidth threshold (e.g., 0.05. If so the next step is S3 in which the rate_{AF3} is updated (should lead into smaller AF3 rate).

If not, the next steps is step S4 where it is determined if smallest UnusedBw_{AF4} value is bigger than HighBwTh higher bandwidth threshold (e.g., 0.15). If so, the next step is step S5 in which the rate_{AF3} is updated (should lead into bigger AF3 rate). If not, then the not change is made as illustrated schematically by step S6. The method is then repeated for the next time period.

It should be appreciated that this method may combine steps S2 and S4 with the next step being step S3, S5 or S6 depending on the result. Alternatively steps S4 can be performed before step S2.
rate_{AF3}=max(rateₘᵢₙ, min(rateₘₐₓ, 1−throughput_{EF}−throughput_{AF4}−UnusedBw_{AF4a})),
   where the EF and AF4 throughput values are from the moment with smallest UnusedBw_{AF4}. UnusedBw_{AF4a} denotes the amount of unused AF4 bandwidth that should always be available. A value of e.g., 0.1 can be used for UnusedBw_{AF4a}.

In general, LowBwTh<UnusedBw_{AF4a}<HighBwTh.

A negative UnusedBw_{AF4} value should immediately (vs. periodic checks) trigger AF3 rate tuning. By doing this, blocking can be prevented.

It should be appreciated that all parameter values are configurable and other values than the ones used as examples are possible as well.

In response to the triggers, all (or some) links under the management of the given ITRM are configured with the new AF3 rate(s) or the QoS Policy Manager (QPM) is instructed to do this.

Performance Evaluation

Simulation Cases and Network Topology

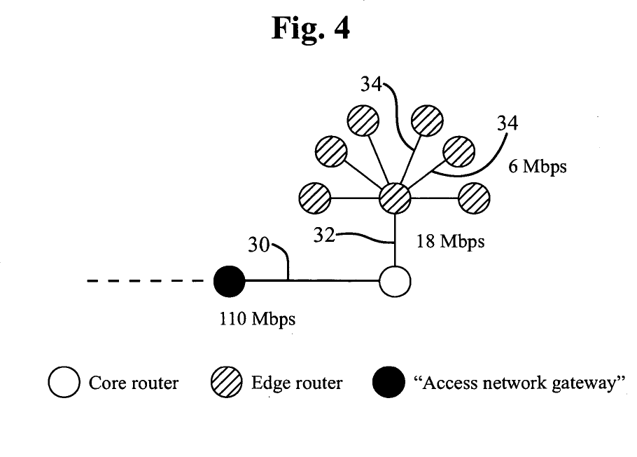

The following four cases are simulated with eight different connection arrival intensities: strict priority like AF weights (strict priority like AF weights are not taken into account in the available bandwidth calculation), normal AF weights, adaptive AF weights and strict priority like AF weights with adaptive reservation limits. The following eight cases are simulated with single arrival intensity only: normal AF weights with adaptive reservation limits, adaptive AF weights with adaptive reservation limits and all the aforementioned six cases with bursty connection arrivals. For admission control, a Flexible CAC instance with three classes: EF, AF1 and AF2 (EF and AF1 belong to RT superclass) is used. Admission control parameters are listed in Table I while the simulation topology is illustrated in FIG. 4.

The access network consists of one fiber link 30 with a bandwidth of 110 Mbps and one microwave (or leased line) branch with substantially less bandwidth (first hop 32 from the fiber: 18 Mbps, second hop 34 from the fiber: 6 Mbps).

TABLE I
ADMISSION CONTROL PARAMETERS.

| | No reservation | | | EF and RT reservation | | |
|---|---|---|---|---|---|---|
| | limit tuning | | | limit tuning | | |
| | SP like | Normal | Adaptive | SP like | Normal | Adaptive |
| | AF | AF | AF | AF | AF | AF |
| Parameters | weights | weights | weights | weights | weights | weights |
| weight_{AF1} | 0.9 | 0.45 | adaptive | 0.9 | 0.45 | adaptive |
| weight_{AF2} | 0.09 | 0.45 | adaptive | 0.09 | 0.45 | adaptive |
| weight_{AF3/BE} | 0.01 | 0.1 | 0.1 | 0.01 | 0.1 | 0.1 |
| T_{W} | N/A | | 10.0 s | N/A | | 10.0 s |
| lowThreshold | N/A | | 0.05 | N/A | | 0.05 |
| highThreshold | N/A | | 0.15 | N/A | | 0.15 |
| Unoccupied | N/A | | 0.1 | N/A | | 0.1 |
| T_{R} | N/A | | | 10.0 s | | |
| Increment | N/A | | | 0.05 | | |
| reservationLimit_{EF} | 10.0 | | | adaptive | | |
| reservationLimit_{RT}_MAX | 10.0 | | | adaptive | | |
| reservationLimit_{AF1} | 10.0 | | | | | |
| reservationLimit_{AF2} | 10.0 | | | | | |
| reservationLimit_{NRT}_MAX | 10.0 | | | | | |
| reservationLimitₜₒₜₐₗ | 10.0 | | | | | |
| loadLimit_{EF} | 0.5 | | | | | |
| loadLimit_{AF1} | 0.5 | | | | | |
| loadLimit_{AF2} | 0.9 | | | | | |
| loadLimit_{RT}_MAX | 0.9 | | | | | |
| loadLimit_{NRT}_MAX | 0.9 | | | | | |
| loadLimitₜₒₜₐₗ | 0.9 | | | | | |
| f(price)ₐₗₗ | 1.0 | | | | | |
| S | 500 ms | | | | | |
| P | 1.0 s | | | | | |
| W | 0.5 | | | | | |

Network Equipment

All routers implement the standard Per-Hop Behaviors (PHB); EF is realized as a priority queue and AF with a Deficit Round Robin (as discussed in M. Shreedhar and G. Varghese, “Efficient Fair Queueing Using Deficit Round-Robin”, IEEE/ACM Transactions on Networking, ol. 4, pp. 375-385, June 1996 which is hereby incorporated by reference) system consisting of three queues. This is the most common way to implement EF and AF in routers. An example: Cisco's LLQ Cisco Systems, Inc., “Low Latency Queueing”, June 2003 which is hereby incorporated by reference.

EF queue is equipped with a token bucket rate limiter (rate: 0.8*link bandwidth, bucket size: 3*MTU=4500 bytes). Default, strict priority like, quanta for AF1, AF2 and AF3 queues are the following: 1800, 180, and 20 (90:9:1). All queue sizes are given in bytes: 5000 for EF, 15000 for AF1, 20000 for AF2 and 25000 bytes for AF3. Weighted Random Early Detection (WRED) as discussed in S. Floyd and V. Jacobson, “Random Early Detection Gateways for Congestion Avoidance”, IEEE/ACM Transactions on Networking, vol. 1, pp. 397-413, August 1993 which is hereby incorporated by reference is applied for AF queues. All WRED queues use AQS (access queue size) Weight of 1.0 (instantaneous queue size dominates). Other WRED parameters (for all AF queues) are the following: MinThresh_{DP1}=MaxThresh_{DP1}=1.0*AQS, MinThresh_{DP2}=MaxThresh_{DP2}=0.883*AQS, MinThresh_{DP3}=MaxThresh_{DP3}=0.767*AQS, MaxDropPr_{DP1-DP3}=1.0. These parameters will result into simplified WRED without queue size averaging or random dropping.

Traffic Characteristics

Connections are set up between the access network gateway and edge routers. New connections arrive at each edge router with exponentially distributed interarrival times with a mean of 1.2-1.9 seconds. This will result in a total arrival intensity of 3.68-5.83 l/s. Holding times are also exponentially distributed with a mean of 100 seconds for RT (EF and AF1) connections and 250 seconds for other connections. Bursty arrivals are created (when needed) with a simple two-state Markov chain, where the transition probabilities from normal state to burst state and vice versa are both 0.1. Connection interarrival times in the normal state are exponentially distributed with a mean of 1.2 seconds while in the burst state the interarrival time is always zero. This will result in higher average arrival intensity.

The traffic mix consists of Voice over IP (VoIP) calls, videotelephony, video streaming (B. Maglaris, D. Anastassiou, P. Sen, G. Karlsson and J. Robbins, “Performance Models of Statistical Multiplexing in Packet Video Communications”, IEEE Transactions on Communications, vol. 36, pp. 834-844, July 1988 which is hereby incorporated by reference only), web browsing (M. Molina, P. Castelli and G. Foddis, “Web Traffic Modeling Exploiting TCP Connections' Temporal Clustering through HTML-REDUCE”, IEEE Network, vol. 12, pp. 46-55, May-June 2000 which is hereby incorporated by reference only and e-mail downloading (V. Bolotin, “Characterizing Data Connection and Messages by Mixtures of Distributions on Logarithmic Scale”, Proceedings of the 16th International Teletraffic Congress, pp. 887-894, Edinburgh, UK, June 1999 which is hereby incorporated by reference).

There are three different service levels within each AF class—their selection is based on subscription information. Service levels do not have any effect on admission control decisions. Signaling traffic between the Bandwidth Broker and all other CAC agents is also modeled—in semi-realistic fashion. CAC agents do send real router load reports to Bandwidth Broker but resource requests and replies are modeled in a statistical fashion. Bandwidth Broker agent is physically located at the gateway that connects the access network to service provider's core network. Service mapping is done according to Table II.

TABLE II
TRAFFIC MIX AND SERVICE MAPPING.

| | | | Share of | Requested |
|---|---|---|---|---|
| | | | offered | bandwidth |
| Service | Service level | PHB | connections | (peak rate) |
| VoIP calls | N/A | EF | 20.0% | 36 kbps |
| Videotelephony | N/A | EF | 20.0% | 84 kbps |
| Video streaming | Gold | AF11 | 4.0% | 250 kbps |
| | Silver | AF12 | 4.0% | 250 kbps |
| | Bronze | AF13 | 4.0% | 250 kbps |
| Guaranteed | Gold | AF21 | 8.0% | 250 kbps |
| browsing | | | | |
| | Silver | AF22 | 8.0% | 250 kbps |
| | Bronze | AF23 | 8.0% | 250 kbps |
| Normal browsing | Gold | AF31 | 8.0% | N/A |
| and e-mail | | | | |
| downloading | | | | |
| | Silver | AF32 | 8.0% | N/A |
| | Bronze | AF33 | 8.0% | N/A |

Simulation Methodology

A modified version of the ns-2 simulator (UCB/LBNL/VINT, “Network Simulator—ns (version 2)”, June 2003.) was used. Six simulations with different seed values are run in each simulated case (95% confidence intervals are used). Simulation time is always 1200 seconds of which the first 600 seconds are discarded as warming period. The tradeoff between connection blocking probability and bottleneck link utilization levels is of interest. Moreover, the following QoS metrics are checked for different traffic aggregates: bottleneck delay, bottleneck packet loss and achieved bit rates for TCP (transmission control protocol)—based traffic sources i.e. TCP throughput. Simple token bucket policers (with shaping and dropping) are used to limit the sending rates of admitted TCP-based sources. During the simulations, it was observed that the bucket size should be zero—otherwise the TCP sources will get too much bandwidth, which has a negative effect on admission control.

Simulation Results

Different Arrival Intensities

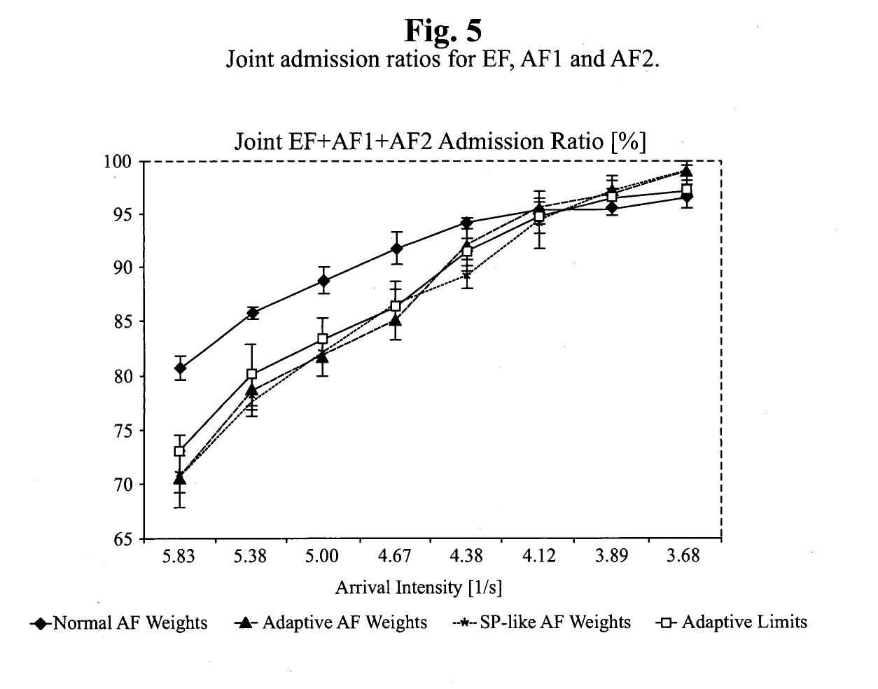

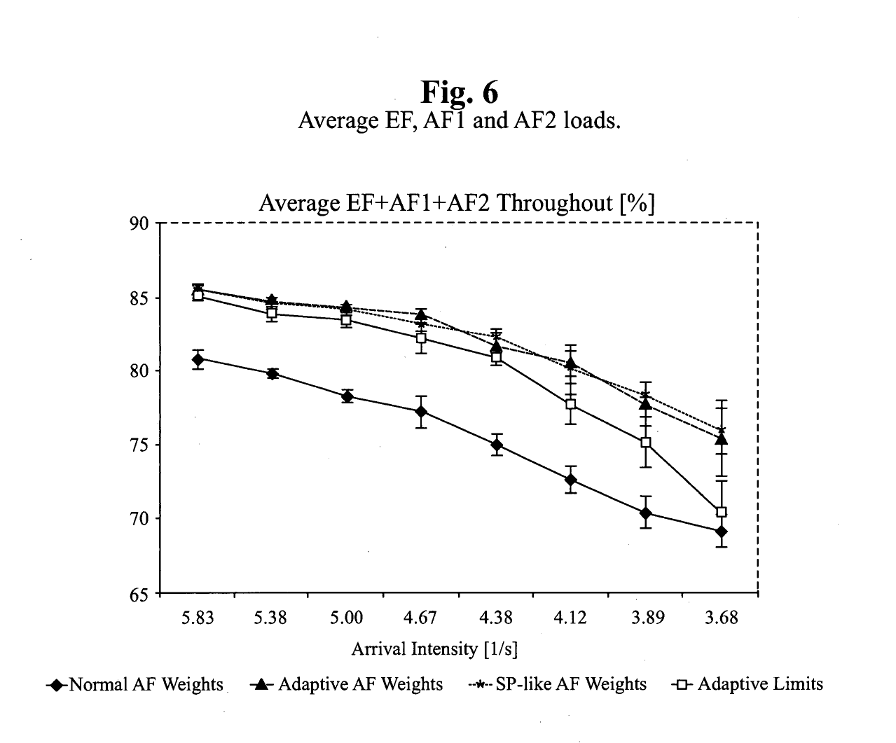

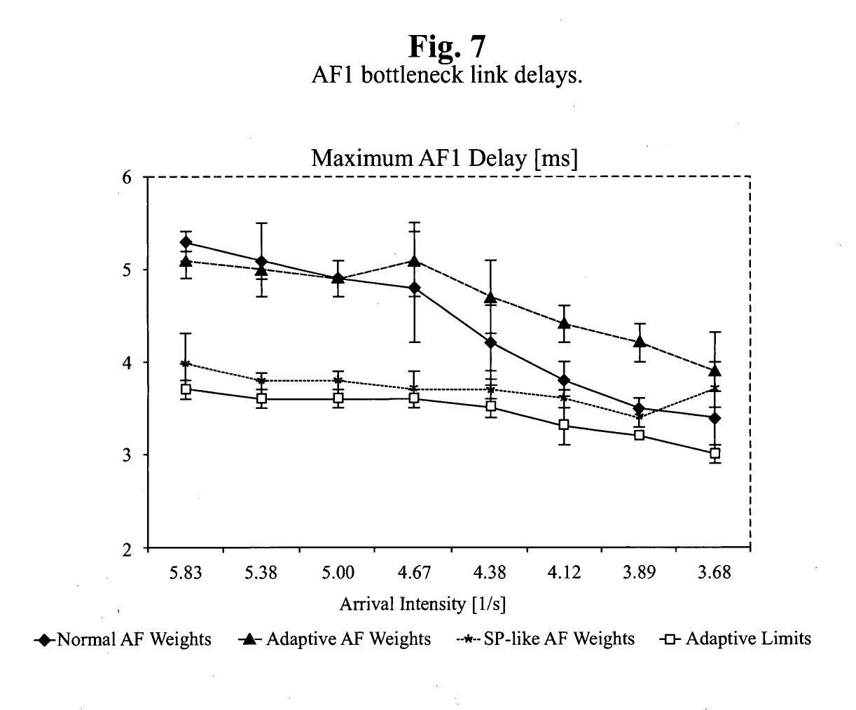

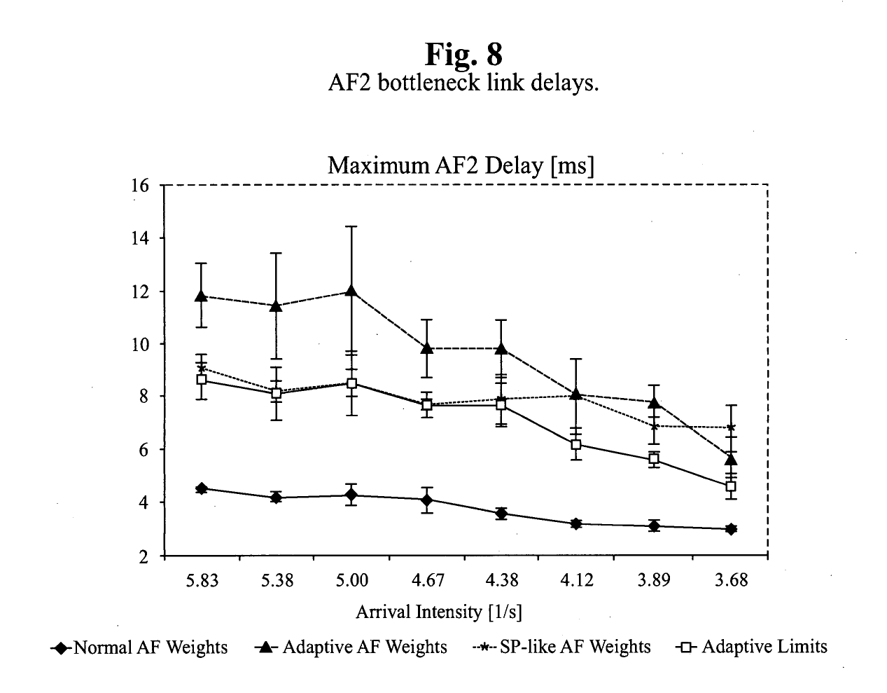

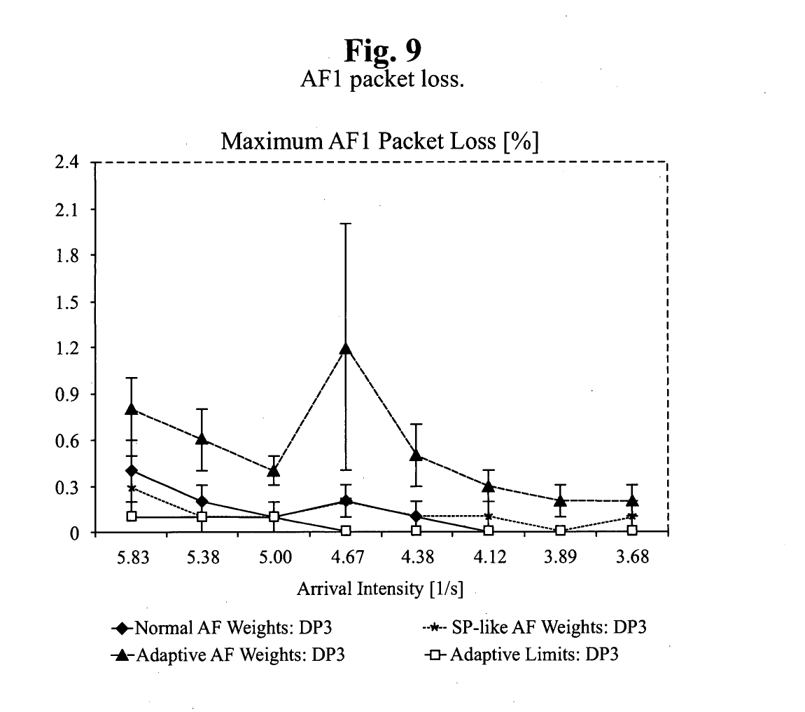

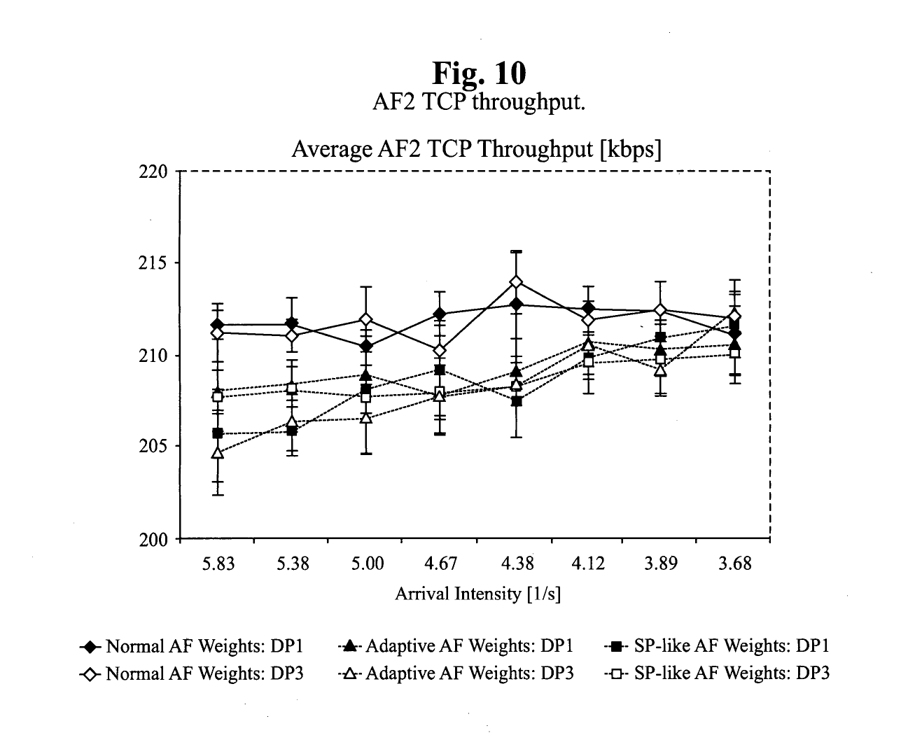

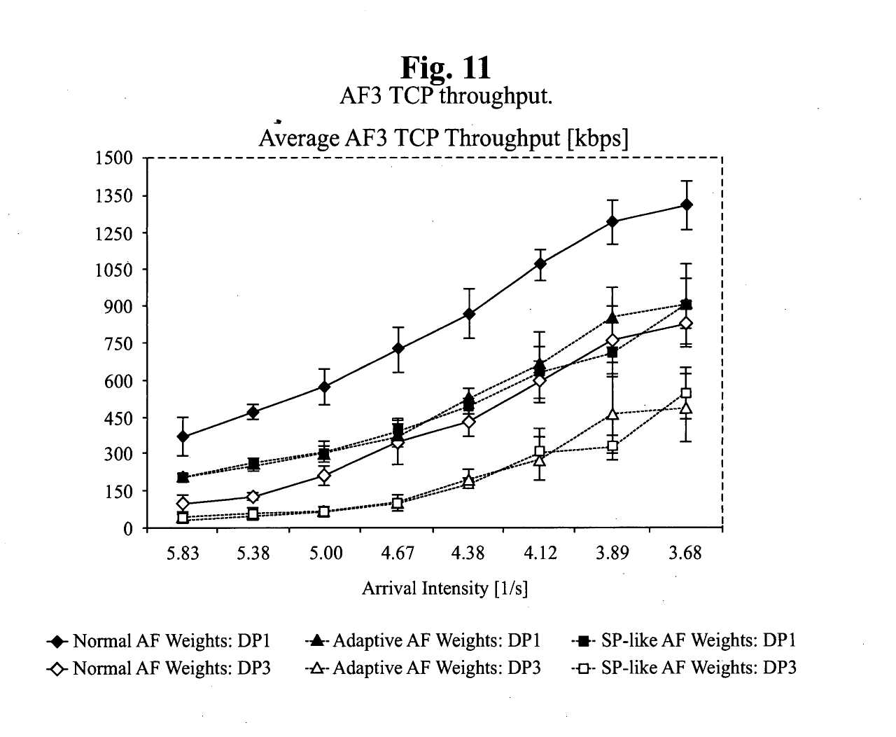

FIGS. 5 to 11 illustrate joint EF+AF1+AF2 admission ratios (FIG. 5), average EF+AF1+AF2 bottleneck link loads (FIG. 6), AF1 and AF2 packet delays over a bottleneck link (FIG. 7 and FIG. 8), AF1 packet loss on a bottleneck link (FIG. 9) and TCP throughput (FIG. 10 and FIG. 11). All graphs present the performance of four different admission control schemes under different connection arrival intensities.

It can be seen that the use of normal non-adaptive AF weights will result in lower average bottleneck link load shown in FIG. 6. Admission ratio for EF+AF1+AF2 connections shown in FIG. 5 does not seem to be a particularly good indicator of the admission control scheme performance as all connections are not equal in terms of bandwidth usage. Adaptive AF weights will results in similar bottleneck link loads as the strict priority like AF weights, which is a surprisingly good result. Adaptive EF and RT reservation limits, however, seem to degrade the performance (lower bottleneck link loads) a little. This is acceptable taking into account the protection they provide against bursty connection arrivals.

Maximum delay graphs for AF1 and AF2 packets are shown in FIGS. 7 and 8. The difference between AF1 and AF2 delays, however, is not very big—In some embodiments there may be no need to have separate AF1 and AF2 classes. This may be true in a single bottleneck case. However, if there are multiple bottleneck links, the differences in end-to-end delays are bigger.

Packet loss shown in FIG. 9 (only AF1 packet loss is graphed—other AF traffic is transported over TCP, where packet losses are natural) does not seem to be a major problem to any of the tested algorithms. As expected, adaptive reservation limits result into smallest packet loss. If lower packet loss rates are desired, the load and reservation limits can be adjusted downwards. It can also be seen in FIG. 10 that AF2 class TCP connections receive their requested resources during high loads as well—this is naturally not the case with AF3 (the Best Effort) class TCP connections shown in FIG. 11.

Single Arrival Intensity (5.83 l/s)

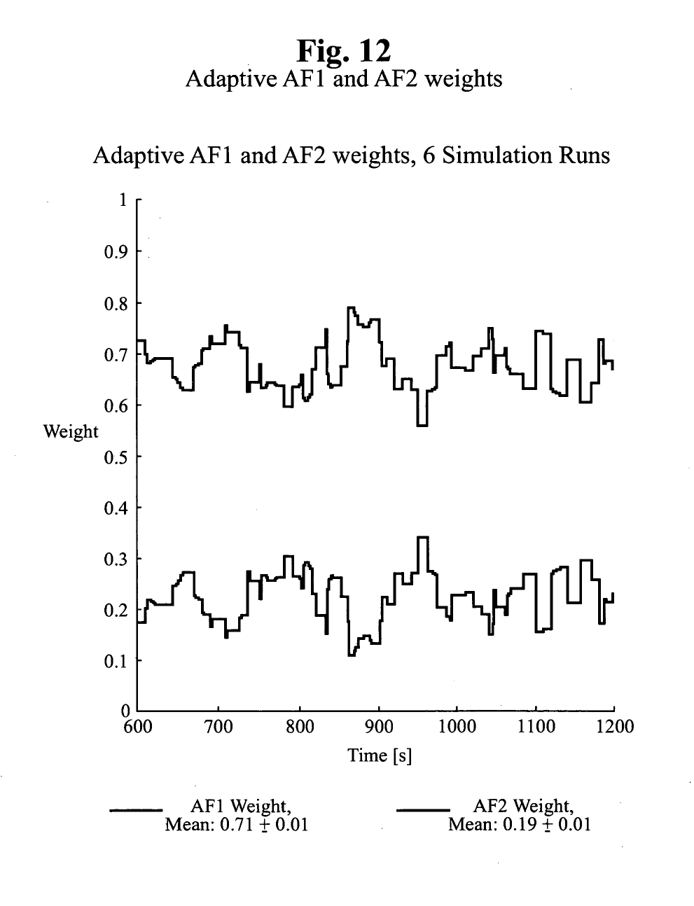

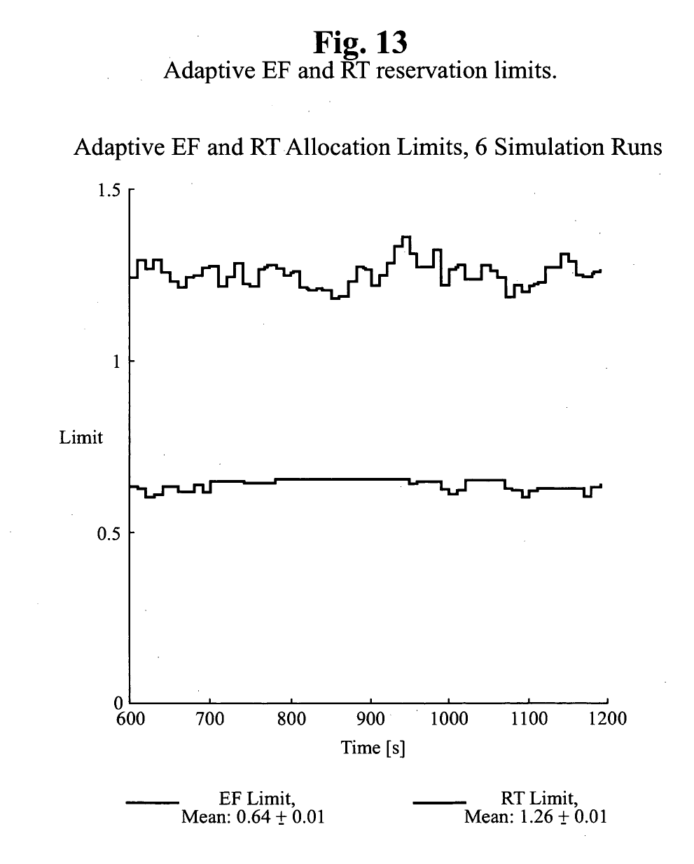

The weights for AF1 and AF2 and reservation limits for EF and RT are illustrated in FIG. 12 and FIG. 13, respectively. Since the traffic mix does not change considerably during the simulation, those weights and reservation limits are quite stable. With different arrival intensities, there would be different values. The purpose of these graphs is to illustrate how AF weights and reservation limits are tuned. Only the first of six simulation runs is graphed—the legend provides mean values from all simulation runs. Table III illustrates the effect of combined AF weight and reservation limit tuning. The performance of this “combined scheme” is at least as good as the performance of the other schemes. Moreover, no negative side-effects were observed.

The Effect of Bursty Arrivals

Since simulations in normal conditions i.e. with Poisson connection arrivals did not give clear enough answers, bursty connection arrivals were needed to find out the differences between the tested schemes. Table IV illustrates the main results: AF1 packet loss is (naturally) minimized when reservation limit tuning is used together with strict priority like AF weights. With normal AF weights, AF1 packet loss is a bit higher. When AF weights are tuned in conjunction with the reservation limits, AF1 packet loss is decreased. This indicates that the two tuning processes are not disturbing each other.

TABLE IV
THE EFFECT OF AF WEIGHT AND EF &
RT RESERVATION LIMIT TUNING.

| | | Average | Maximum | Maximum |
|---|---|---|---|---|
| | EF + AF1 + AF2 | EF + AF1 + AF2 | AF1 and | AF1 |
| | admission | bottleneck | AF2 delays | packet |
| Method | ratio [%] | load [%] | [ms] | loss [%] |
| SP like AF weights | 71.0 ± 1.7 | 85.5 ± 0.3 | 4.0 ± 0.3 | 0.3 ± 0.2 |
| (90:9:1), no | | | 9.1 ± 0.5 | |
| tuning | | | | |
| Normal AF weights | 80.7 ± 1.1 | 80.8 ± 0.7 | 5.3 ± 0.1 | 0.4 ± 0.2 |
| (45:45:10), no | | | 4.5 ± 0.1 | |
| tuning | | | | |
| AF weight tuning | 70.5 ± 2.6 | 85.6 ± 0.3 | 5.1 ± 0.2 | 0.8 ± 0.2 |
| | | | 11.8 ± 1.2 | |
| SP like AF | 72.9 ± 1.6 | 85.1 ± 0.2 | 3.7 ± 0.1 | 0.1 ± 0.0 |
| weights, EF & RT | | | 8.6 ± 0.7 | |
| reservation limit | | | | |
| tuning | | | | |
| Normal AF weights, | 81.6 ± 0.7 | 79.9 ± 0.3 | 5.0 ± 0.3 | 0.2 ± 0.1 |
| EF & RT | | | 4.5 ± 0.3 | |
| reservation limit | | | | |
| tuning | | | | |
| AF weight and EF & | 74.2 ± 1.0 | 84.5 ± 0.4 | 5.1 ± 0.3 | 0.4 ± 0.1 |
| RT reservation | | | 10.5 ± 0.9 | |
| limit tuning | | | | |

TABLE V
THE EFFECT OF BURSTY ARRIVALS.

| | | Average | Maximum | Maximum |
|---|---|---|---|---|
| | EF + AF1 + AF2 | EF + AF1 + AF2 | AF1 and | AF1 |
| | admission | bottleneck | AF2 delays | packet |
| Method | ratio [%] | load [%] | [ms] | loss [%] |
| SP like AF weights | 37.6 ± 1.7 | 88.2 ± 0.1 | 4.9 ± 0.4 | 1.4 ± 1.2 |
| (90:9:1), no | | | 28.1 ± 14.8 | |
| tuning | | | | |
| Normal AF weights | 45.2 ± 2.1 | 85.5 ± 0.5 | 9.4 ± 1.4 | 7.8 ± 4.1 |
| (45:45:10), no | | | 7.5 ± 0.7 | |
| tuning | | | | |
| AF weight tuning | 37.0 ± 2.2 | 88.1 ± 0.3 | 7.5 ± 0.6 | 6.3 ± 2.0 |
| | | | 28.4 ± 4.5 | |
| SP like AF | 41.4 ± 1.9 | 86.8 ± 0.2 | 4.0 ± 0.1 | 0.1 ± 0.1 |
| weights, EF & RT | | | 10.4 ± 0.7 | |
| reservation limit | | | | |
| tuning | | | | |
| Normal AF weights, | 47.4 ± 1.7 | 84.7 ± 0.4 | 6.9 ± 0.7 | 1.4 ± 0.4 |
| EF & RT | | | 7.2 ± 0.8 | |
| reservation limit | | | | |
| tuning | | | | |
| AF weight and EF & | 41.9 ± 1.8 | 86.7 ± 0.2 | 5.9 ± 0.2 | 1.0 ± 0.4 |
| RT reservation | | | 12.6 ± 1.0 | |
| limit tuning | | | | |

In embodiments of the invention, there is a need for normal (vs. strict priority like) AF weights—this embodiment seeks to protect Best Effort (or “Best Effort”, which is AF3 in this embodiment) traffic. Thus, AF weights are taken into account in the admission decisions. Simulations show that static AF weights result into lower bottleneck link utilization than adaptive AF weights. Moreover, adaptive reservation limits are an effective way to protect oneself against bursty connection arrivals and maintain high bottleneck link utilization.

A further embodiment of the present invention will now be described which may be used in conjunction with the previously described embodiments. A CAC algorithm is provided for ITRM/Bandwidth Broker, which again does not assume “strict priority-like” weight for AF4 queues. The set of AF scheduling weights can be the same for all links under the management of a given ITRM/Bandwidth Broker, or the weights are tuned individually for each link. However, the latter approach is complex and oscillation-prone.

Scheduling weight & CAC algorithm tuning process receives periodic input about the ratio of blocked/offered AF4 connections and unused AF4 bandwidth for every link within the ITRM/Bandwidth Broker area. It should be appreciated that some other inputs such a queue filling level, packet loss and throughput could be used as well. If certain thresholds are reached, new scheduling weight for AF4 queues (and for other AF queues as well, maintaining the existing AF3:AF2:AF1 weight ratio) and CAC algorithm is calculated. The embodiment following is one way to do this.

Once the new AF weights have been calculated, all (or alternatively just some) links under the management of given ITRM/Bandwidth Broker are configured with the new AF weights. The CAC algorithm running in ITRM/Bandwidth Broker is also updated with the new AF4 weight(s).

Embodiments of the present invention can be used both in Nokia's ITRM admission control framework and in the modified Bandwidth Broker framework (see J. Lakkakorpi, “Simple Measurement-Based Admission Control for DiffServ Access Networks”, Proceedings of SPIE ITCom 2002, Boston, USA, July-August 2002.) The ITRM case is presented here as an example.

ITRM Controlled AF4 Weight Tuning

A new CAC algorithm that does not assume “strict priority-like” weight for AF4. It is assumed that there is CAC for all traffic mapped to EF—including NRT Iur' traffic.
UnusedBw_{EF}=bw×(TLim_{EF}−throughput_{EF})

$${UnusedBw}_{AF4} = bw \times min ( ( {TLim}_{AF4} - {throughput}_{AF4} ) , ( 1 - {throughput}_{EF} - \frac{{throughput}_{AF4}}{{}_{}^{\cdot }{w}{}_{AF4}^{}} ) )$$
UnusedBw_{RT}=bw×(TLim_{RT}−throughput_{EF}−throughput_{AF4})
W_{AF4} is the scheduling weight for AF4 queue (a reasonable range could be, for example, from wₘᵢₙ=0.3 to wₘₐₓ=0.99—very small w_{AF4} values might have too big an impact for UnusedBw_{AF4}) so that the sum of all AF weights is one. Either the same w_{AF4} can be used for all links or different weights for different links can be used.

$${UnusedBw}_{CLASS} := {UnusedBw}_{CLASS} * \frac{1}{{x}^{ITRM\_prm \_share}}$$
BLim_{CLASS,path}=min(UnusedBw_{CLASSlink}|∀linkεpath)+allocated_{CLASS,path}
For EF connections, check at BTS that:
   requested rate+allocated_{EF, path}≦BLim_{EF, path}
   requested rate+allocated_{RT, path}≦BLIm_{RT, path}
For AF4 connections, check at BTS that:
   requested rate+allocated_{AF4, path}≦BLim_{AF4, path}
   requested rate+allocated_{RT, path}≦BLim_{RT, path}
      It should be noted that allocated_{RT}=allocated_{EF}+allocated_{AF4}
      Triggers

ITRM monitors AF4 connection blocking ratio (The BTS notifications for the BTSs to ITRM could be extended to include the numbers offered and blocked AF4 connections during the last SWLength every PLength Interval so that ITRM could calculate the overall AF4 blocking ration every PLength interval) and the smallest UnusedBw_{AF4}/bw value(s) during a measurement period (PLength). This may be dependent on whether the same or different AF links are applied or not. After each periodic check, this value is (or these values are) reset.
A sliding window of SWLength (e.g., 30) minutes is used for gathering the AF4 connection blocking ratio statistics.
Periodic checks are made every PLength (e.g., 10) minutes. If certain thresholds are reached, calculate new weight(s) for AF4 queues.
If AF4 blocking ratio is too big (>BlockingTh, e.g., 2%) or smallest UnusedBw_{AF4}/bw value is smaller than LowBwTh (e.g., 0.05), update w_{AF4} (should lead into bigger weight).
If AF4 blocking ratio is zero and smallest UnusedBw_{AF4}/bw value is bigger than HighBwTh (e.g., 0.15), update w_{AF4} (should lead into smaller weight).

$${w}_{AF4} = max ( {w}_{min} , min ( {w}_{max} , \frac{{throughput}_{AF4}}{1 - {throughput}_{EF} - {UnusedBw}_{AF4a}} ) ) ,$$

where the EF and AF4 throughput values are from the moment with smallest UnusedBw_{AF4}/bw. UnusedBw_{AF4a} denotes the amount of unused AF4 bandwidth that we would like to be always available. A value of e.g., 0.1 can be used for UnusedBw_{AF4a}. In general, LowBwTh<UnusedBw_{AF4a}<HighBwTh.
A negative UnusedBw_{AF4}/bw value should immediately (vs. periodic checks) trigger AF4 weight tuning. By doing this, blocking can be prevented.
The use of AF4 blocking ratio as indicator is needed because of possible blocked high-capacity AF4 requests that do not necessarily show through unused bandwidth values.

All parameter values are configurable and other values than the ones used as examples are possible as well.

The following actions are carried out:

Configure all (or some) links under the management of the given ITRM/Bandwidth Broker with the new AF4 weight(s) or tell QoS Policy Manager (QPM) to do this.

Update the CAC algorithm running in ITRM with the new AF4 weight(s). (If Policy Manager has accepted the new weight.)

In this embodiment, the CAC in ITRM/Bandwidth Broker and tuning of router scheduling weights are linked. In addition to router statistics—such as queue filling level, packet loss and throughput—the tuning of scheduling weights is based on connection blocking ratios and unused bandwidth values. Whenever the scheduling weights are tuned, the CAC algorithm is also updated to reflect the new weights.

Embodiments of the present invention have been described in the context of an IP packet network using AF and/or EF PHB. It should be appreciated that the embodiments of the present invention can be used with other examples of traffic classes. The classes may not based on IP packets or may use a mix of IP packets and non IP based packets. Embodiments of the invention have been described in the context of a DiffServ system. It should be appreciated that embodiments of the present invention may be used in different systems.

Embodiments of the invention have been described in the context of one class occupying a majority of the bandwidth and a second class being tuned in dependence on activity of the one class. It should be appreciated that the activity of more than one class can be examined and more than one class may be tuned.

1. A method of for controlling an admission of a connection comprising:
a) providing a plurality of classes;
b) reserving for at least one class a portion of a bandwidth;
c) determining usage related information by at least one of the classes to which a respective portion of said bandwidth has been reserved; and
d) controlling admission of at least one class, different from the at least one class for which usage has been determined, said admission taking into account said determined usage related information.

2. A method as claimed in claim 1, wherein the determining step comprises determining the usage related information of a class allocated a majority portion of said bandwidth.

3. A method as claimed in claim 1, wherein the determining step comprises determining usage related information of a real time class.

4. A method as claimed in claim 1, wherein the controlling step comprises controlling the admission of the at least one class comprising a non real time traffic class.

5. A method as claimed in claim 1, wherein the controlling step comprises dividing the at least one class into a plurality of subclasses.

6. A method as claimed in claim 1, wherein the determining step and the controlling step are repeated at regular intervals.

7. A method as claimed in claim 1, wherein the determining step comprises determining the usage related information over a predetermined period.

8. A method as claimed in claim 1, wherein the determining step comprises determining if said usage related information satisfies a predetermined criteria and wherein the step of controlling is performed only if said predetermined criteria is satisfied.

9. A method as claimed in claim 1, wherein said determining step comprises at least one of:
determining unused bandwidth allocated to said at least one class;
determining a blocking ratio for said at least one class; and
determining an unused portion of an allocated bandwidth for said at least one class.

10. A method as claimed in claim 1, wherein said controlling step comprises taking into account at least one of a throughput of the at least one class for which the usage is determined and a throughput of the at least one class for which the admission is to be determined in the controlling step.

11. A method as claimed in claim 1, wherein said determining step comprises determining a scheduling weight for said at least one class.

12. A method as claimed in claim 1, wherein the further comprising:
reserving, for the at least one class different from the at least one class for which the usage has been determined, a basic bandwidth allocation which is alterable in the controlling step.

13. A method as claimed in claim 1, wherein the reserving step comprises arranging the portion of bandwidth reserved for admission in the controlling step to be less than or equal to a predetermined maximum.

14. A method as claimed in claim 1, further comprising the step of:
configuring a plurality of links between routing nodes based on said usage related information.

15. A method as claimed in claim 1, further comprising the step of:
updating a connection admission control algorithm based on said usage related information.

16. A method as claimed in claim 1, wherein the providing step comprises providing said classes comprising traffic classes of IP packets in a differentiated Services network.

17. A method as claimed in claim 15, wherein the providing step comprises providing said classes comprising one or more of assured forwarding classes and expedited forwarding classes.

18. A method as claimed in claim 1, wherein the controlling step comprises taking into account usage information of the class to be admitted.

19. A routing network comprising:
a plurality of routing nodes, at least one of said routing nodes being configured to provide connection admission control and at least one of said routing nodes is configured to
control the reserving of, for at least one traffic class, a portion of a bandwidth, at least one of receive and determine usage related information of at least one of the classes for which a respective portion of said bandwidth has been reserved; and
control admission of at least one traffic class, different from the at least one traffic class for which the usage related information has been determined, said admission taking into account said determined usage related information.
